(19) United States
(12) Patent Application Publication
(10) Pub. No.: US 2005/0071640 A1
(43) Pub. Date: Mar. 31, 2005

(54) Method and apparatus for authenticating data

(75) Inventors: Eric Sprunk, Carlsbad, CA (US); Paul Moroney, Encinitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: General Instrument Corporation, Horsham, PA (US)

(21) Appl. No.: 10/796,712

(22) Filed: Mar. 9, 2004

Related U.S. Application Data
(60) Provisional application No. 60/505,915, filed on Sep. 25, 2003.

(51) Int. Cl. H04L 9/00

(52) U.S. Cl. 713/176

(57) ABSTRACT

A method for authenticating a string of data stored remotely from the processor. A bifurcated hash routine can be utilized to provide a check root along with a putative new root for a revised string of data. The check root can be compared with the previously determined initial root. If the check root matches the initial root, the new root is accepted in view of the fact that it was computed concurrently with the check root.

### CROSS-REFERENCES TO RELATED APPLICATIONS

This application claims the benefit of U.S. Ser. No. 60/505,915 for “Method and Apparatus for Authenticating Data”, filed Sep. 25, 2003 which is hereby incorporated herein by reference in its entirety for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

The present invention is related to methods and apparatuses for authenticating data. In particular, some embodiments of the invention relate to performing hashing routines on data stored remotely from a processor.

### BACKGROUND

Oftentimes, it is necessary to store large blocks of data remotely from a processor in remote memory. This is due to the fact that the processor does not have enough memory capacity to store the entire block of data. As a result of this, the data cannot be secured sufficiently. Oftentimes, the processor will access a subportion of the set of the data and operate on that subportion before replacing the subportion back in the larger block of data stored in memory. However, the processor does not necessarily check whether the remaining portions of the set of data went unchanged during the operation.

In the area of digital rights management, for example, it is often necessary to store a long string of data at a location remote from a processor. As the user's entitlement privileges change, the digital rights management information is updated accordingly. Therefore, a processor might obtain a block of data upon which to perform an update and then store it back remotely from the processor. Again, in doing so, the processor is unable to ensure that the entire string of data stored remotely from the processor has not been tampered with.

Thus, the current systems for storing data, such as data used for digital rights management, are susceptible to attack when large amounts of data must be stored remotely from a processor.

### SUMMARY

One embodiment of the invention provides a method for authenticating data. For example, a set of N information blocks can be authenticated by obtaining an initial hash value for each set of N information blocks, where N is an integer; altering one of the N information blocks from the set of N information blocks so as to form a revised set of N information blocks; calculating a revised hash value for the revised set of N information blocks; while calculating a check hash value for the N information blocks; then comparing the check hash value with the initial hash value; and accepting the revised hash value for the revised set of N information blocks if the check hash value matches the initial hash value.

Another embodiment of the invention provides a method of authenticating a set of N information blocks by obtaining an initial root key for a set of data comprised of a plurality of blocks of data, the root key operable for authenticating the set of data; calculating hash keys for the plurality of blocks of data so that each of the hash keys corresponds to only one of the blocks of the data and so that each of the blocks of data corresponds to only one of the hash keys; storing the hash keys for the plurality of blocks of data; altering one of the blocks of data so as to form a revised block of data; calculating a second hash key for the revised block of data, wherein the revised block of data immediately prior to being revised corresponds to a first hash key and wherein the first hash keys is one of the hash keys for the plurality of blocks of data; utilizing the stored hash keys, including the first hash key, to calculate a check root key while utilizing the stored hash keys and the second hash key substituted in place of the first hash key to calculate a new root key; comparing the check root key with the initial root key; and accepting the new root key if the check root key matches the initial root key.

Further embodiments of the invention will be apparent to those with ordinary skill in the art from a consideration of the following descriptions taken in conjunction with accompanying drawings wherein certain methods, apparatuses, and articles of manufacture for practicing the embodiments of the invention are illustrated.

### BRIEF DESCRIPTION OF THE DRAWINGS

FIG. 1 is a flowchart illustrating a method for authenticating data using a hash routine, according to one embodiment of the invention.

FIG. 2 is a block diagram of a computer system for implementing a hash routine, according to one embodiment of the invention.

FIGS. 3A, 3B, and 3C are a flowchart illustrating a method of hashing data, according to one embodiment of the invention.

FIG. 4A is a diagram illustrating a hashing routine for calculating an initial message authentication code for use in one embodiment of the invention.

FIG. 4B is a diagram illustrating a concurrent hashing routine, according to one embodiment of the invention.

FIGS. 5A and 5B are a flowchart illustrating a method for authenticating data using a concurrent hashing routine, according to one embodiment of the invention.

FIG. 6 illustrates a diagram of performing a binary tree hashing algorithm for use in one embodiment of the invention.

FIG. 7 illustrates a diagram for implementing a hashing routine, according to one embodiment of the invention.

FIGS. 8A, 8B, and 8C are a flowchart for illustrating a method of hashing data according to one embodiment of the invention.

### DETAILED DESCRIPTION

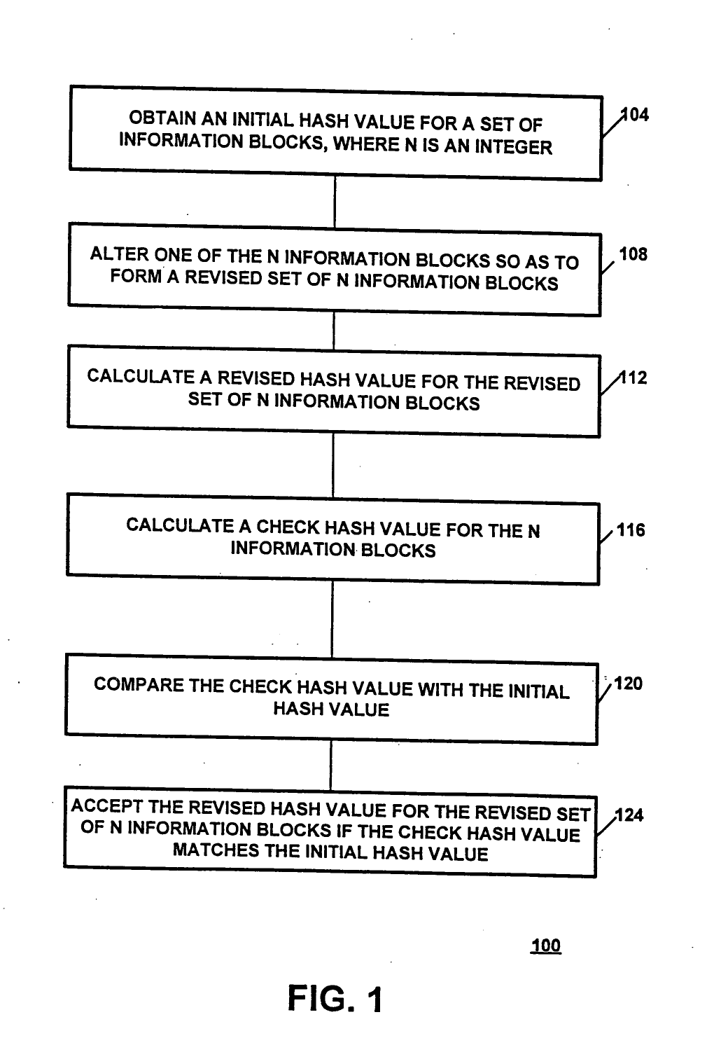

Referring now to FIG. 1, one embodiment of the invention is illustrated by flowchart 100. Flowchart 100 illustrates how a processor can authenticate information stored remotely from a processor using a hash algorithm. First, the processor obtains an initial hash value for a set of N information blocks where N is an integer, as shown in block 104. In block 108, one of the N information blocks is altered so as to form a revised set of N information blocks. A revised hash value for the revised set of N information blocks is calculated in block 112. Furthermore, a check hash value is calculated for the N information blocks in block 116. The check hash value is compared with the initial hash value in block 120. If the check hash value matches the initial hash value, the revised hash value is accepted, as shown in block 124. Thus, this embodiment of the invention allows one to calculate an initial hash value, to compute a check hash value, to compute a revised hash value, and to replace the initial hash value with the revised hash value if the check hash value matches the initial hash value. Use of the word “hash” is intended to refer to use of a hashing algorithm, rather than a particular hashing algorithm. For example, the Secure Hashing Algorithm (SHA) is an example of a hashing algorithm. However, it is not required that SHA be used.

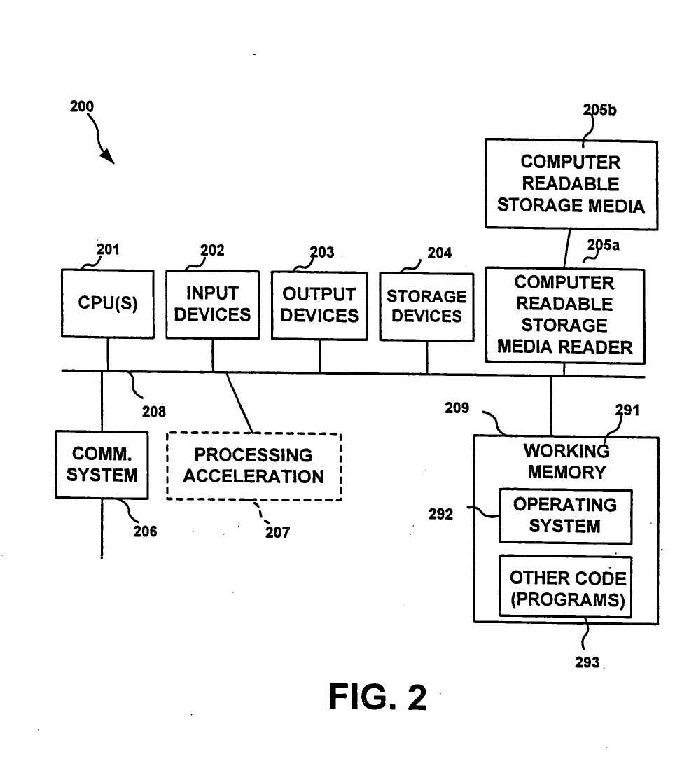

This embodiment of the invention can be implemented using the hardware shown in FIG. 2. Namely, a processor in a computer system such as CPU 201 can be utilized to implement the hashing algorithm. The stored data can be stored on one of the storage devices 204. Thus, the CPU 201 can retrieve data stored in storage device 204 and implement a hashing routine on the data. System 200 is shown comprised of hardware elements that are electrically coupled via bus 208, including a processor 201, input device 202, output device 203, storage device 204, computer-readable storage media reader 205a, communications system 206 processing acceleration (e.g., DSP or special-purpose processors) 207 and memory 209. Computer-readable storage media reader 205a is further connected to computer-readable storage media 205b, the combination comprehensively representing remote, local, fixed and/or removable storage devices plus storage media, memory, etc. for temporarily and/or more permanently containing computer-readable information, which can include storage device 204, memory 209 and/or any other such accessible system 200 resource. System 200 also comprises software elements (shown as being currently located within working memory 291) including an operating system 292 and other code 293, such as programs, applets, data and the like.

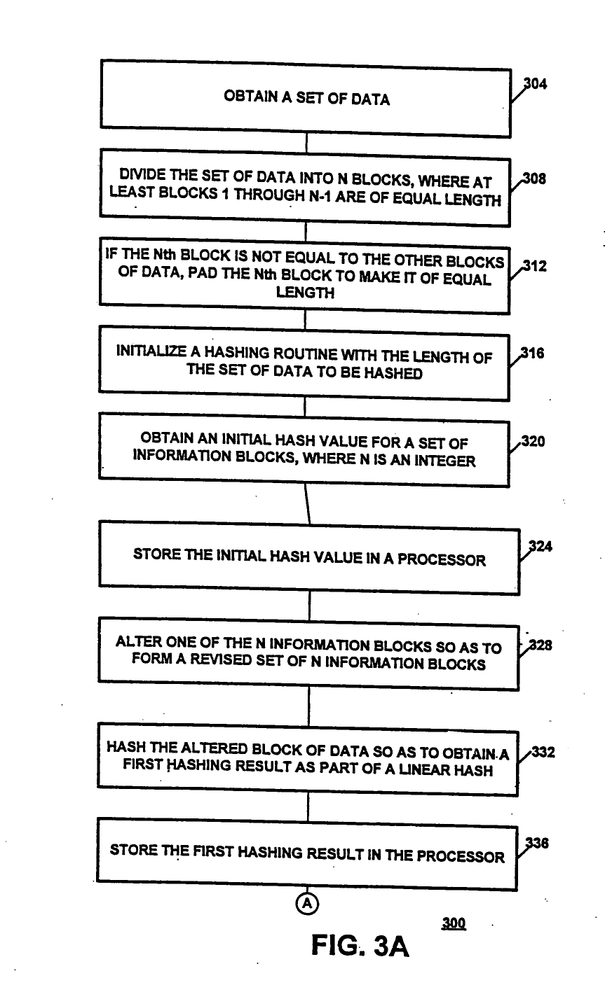

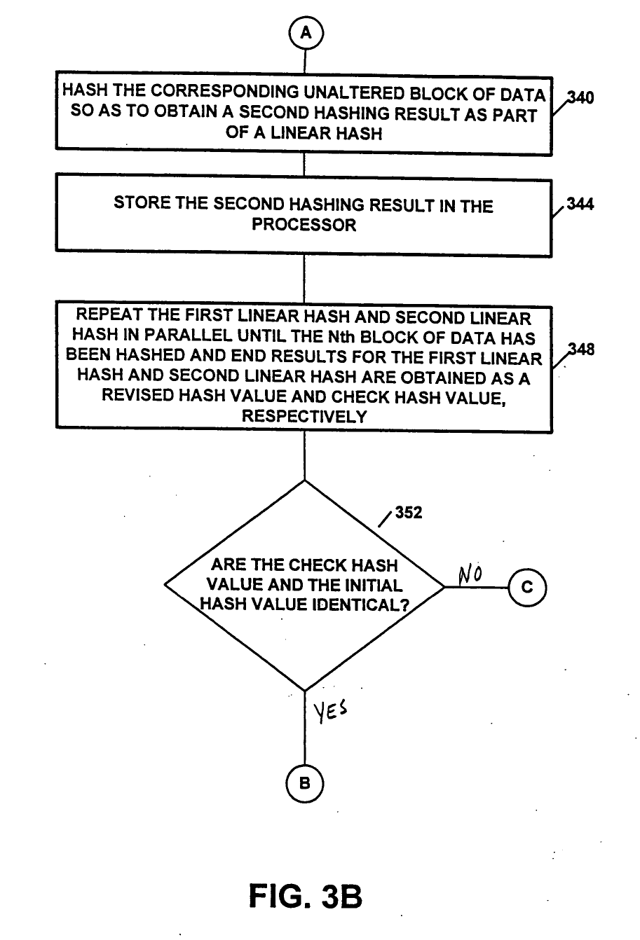

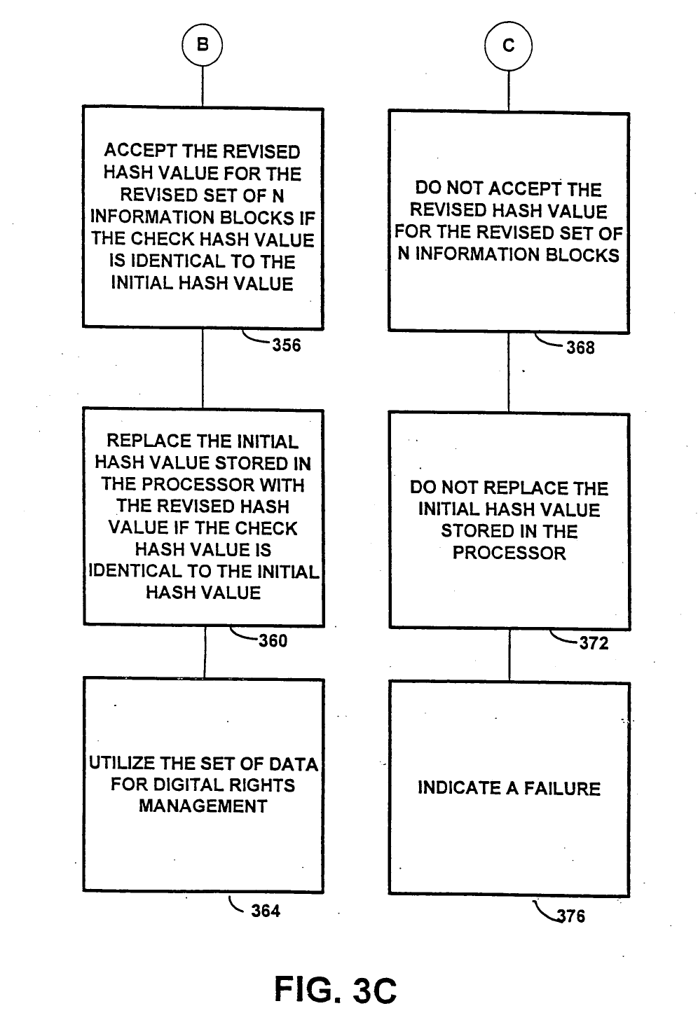

FIGS. 3A, 3B, and 3C illustrate another embodiment of the invention as shown in flowchart 300. FIGS. 3A, 3B, and 3C are an example of an embodiment of the invention as might be used for digital rights management in the cable industry. In the cable industry, a wide variety of programming material is distributed through the cable distribution system. A set-top box or other user equipment on the user premises is programmed to determine which services that particular customer is entitled to receive. The data stored in such a set-top box is often referred to as digital rights management data. This data can be used to determine which programs the customer can receive. However, this data may be too large to be stored on the processor itself and therefore must be stored remotely from the processor. As a result, it is subject to attack by those desiring to obtain services for free. Therefore, the processor in the user equipment needs to authenticate the data before using it. Thus, FIGS. 3A, 3B, and 3C illustrate an example of such an authentication process.

In flowchart 300, an initial set of data is obtained in block 304. This set of data can be divided into N blocks, where at least blocks 1 through N−1 are of equal length, as shown in block 308. If the Nth block is not equal to the other blocks of data as far as length is concerned, the Nth block can be padded with additional information to make it of equal length with the other blocks as shown in block 312. In block 316, a hashing routine is initialized with the length of the set of data to be hashed. This initial set of data has been hashed to obtain an initial hash value for the set of N information blocks as shown in block 320. This initial hash value or root MAC is stored as the initial hash value in the processor, as shown in block 324.

When it comes time for the set of data to be revised, such as a change in the entitlement information for receiving cable programs, the external data stored remotely from the processor will need to be revised. However, only a portion of the data will need to be revised rather than the entire string of data. Thus, the user needs to ensure that the data can be revised in the inappropriate location without a change occurring without authorization.

Next, one of the N information blocks is altered so as to form a revised set of N information blocks for the set of data, as shown in block 328. The altered block of data is hashed so as to obtain a first hashing result as part of a linear hash in block 332. In block 328, one of the N information blocks is altered so as to form a revised set of N information blocks. At this point, a new root key needs to be computed for storing in the processor for future authentication of the revised N information blocks. Therefore, a hashing routine is implemented on the revised set of N information blocks. The hashing routine proceeds as before until the revised block of data is encountered. At this stage, a bifurcation takes place so as to compute two hashing algorithms on the data. Thus, in conducting a linear hash, the previously unaltered block of data is input into the hashing algorithm. This result is stored for later use by the processor.

Thus, upon the occurrence of the altered block of data, the processor inputs the altered block of data to the hash routine so as to obtain a first hashing result as part of the linear hash according to block 332. This result of the hashing algorithm is stored in the processor as shown in the block 336. The bifurcated hashing routine then inputs the unaltered block of data so as to obtain a second hashing result as part of a linear hash according to block 340. This second hashing result is also stored in the processor, as shown in block 344. Thus, the bifurcated hashing routine now has the results from the chain of data using the altered data for one path and the unaltered data from before for the other path. The hashing routines continue in block 348 by inputting subsequent blocks of data and hashing them in parallel along the two hash branches until the Nth block of data has been hashed. Calculating a hash in parallel should be understood to include the situation where a processor obtains a piece of data and stores it within the processor so that the processor can perform a first hash on the piece of data, store the result of the first hash and also perform a second hash on the piece of data, and store the result of the second hash. In a chip that possess two channels of combinational logic in firmware, the first and second hashes could literally be performed at the same time, wherein a first channel processes the first hash and a second channel processes the second hash. Upon completion of the Nth block of data, a hashing result for the first linear hash and for the second linear hash are obtained. Since the first linear hash received the revised information, it is a putative new hash value while the second linear hash result is a check hash value.

At this stage, the check hash value is compared with the initial hash value stored in the processor, as shown in decision block 352. If they match, the revised hash value is accepted for the revised set of N information blocks, as shown in block 356. It thus can replace the initial hash value stored in the processor as shown by block 360. Thus, the set of data for digital rights management has been revised and authenticated as only a revision to the block of data intended to be revised. The authentication process shows that no subsequent blocks of data were revised because the check hash value provided the same result as the initial hash value.

If the check hash value does not match the initial hash value in decision block 352, the putative revised hash value is not accepted for the revised set of N information blocks, as shown in block 368. Therefore, the initial hash value is not replaced, but remains stored in the processor, as shown in block 372. Furthermore, a failure can be indicated to the customer or the cable operator as shown by block 376.

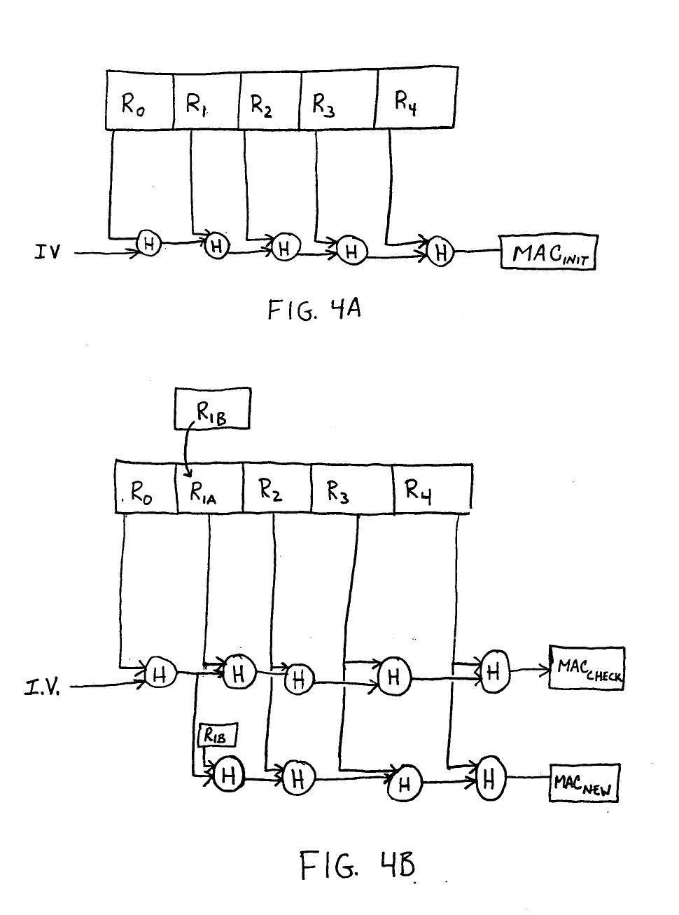

FIGS. 4A and 4B illustrate the embodiments discussed in FIGS. 1 and 3A, 3B, and 3C. Namely, FIG. 4A illustrates the calculation of an initial root value for a string of data. The string of data is shown divided into blocks R₀, R₁, R₂, R₃, and R₄. A hashing routine is implemented to obtain the initial root value for the string of data. The hash value is initiated with an initialization vector shown as “IV” being input to a hashing routine as well as the first block of data R₀. The result of the first hash is input to a second hash along with data block R₁. Similarly, blocks R₂, R₃, and R₄ are input into the hashing routine. The result is indicated as MAC_{INIT}. Thus, FIG. 4A illustrates the calculation of the initial root value for the string of data.

FIG. 4B illustrates the embodiment of the invention for bifurcated hashing of a revised set of data. In FIG. 4B, an initialization vector is input to a hashing routine along with the first block of data R₀ which is an unchanged block of data in the set of data. A block of data being revised by the processor is shown as block R_{1B} with an arrow indicating that it is being inserted in place of block R_{1A}. Thus, after hashing the first block of data R₀, the processor will note the revised block of data R_{1B}. Therefore, it will bifurcate so that it can hash one path for the original set of data and another path for the revised set of data. By calculating the hash for the original set of data concurrently with calculating the hash for the revised set of data, the processor ensures that data cannot be revised in between the processing. Namely, an attacker might try to revise R₂, R₃, or R₄ in an intermediate time frame when the processor was calculating either MAC_{CHECK} or MAC_{NEW}. Therefore, FIG. 4B shows the hashing of the subsequent blocks of data in a concurrent fashion such that each block of data is loaded into the processor only once.

Once the processor has hashed the first block of data R₀, and encounters the revised block of data R_{1B}, which has been changed from block R_{1A}, it bifurcates into two hashing algorithms. It uses the results of the hash of R₀ as an input along with old data R_{1A} to compute a hash result. This hash result is stored in the processor and the first path is suspended. The processor then performs a hash on the results of the hash of R₀ using new data R_{1B}. Again, this hash result is stored and the second path of the bifurcated hashing is suspended. Purportedly unchanged block of data R₂ is then input with the previously suspended data for the first hash. Again, the result is stored and that hash is suspended while R₂ is used along with the previously stored data for the second path. A hash is performed on these inputs and the results stored again in the processor. The two hashes then operate in a similar fashion on blocks R₃ and R₄. When finished, the result is MAC_{CHECK} and MAC_{NEW}. MAC_{CHECK} is the computed root value for the unaltered R_{1A} data, whereas MAC_{NEW} is the hash result for the set of data with R_{1B} substituted in place of R_{1A}. At this stage, MAC_{CHECK} is compared to MAC_{INIT} to ensure that they match. If they do not match, then one of blocks R₀, R₂, R₃ or R₄ has been altered without authorization. Thus, MAC_{NEW} cannot be accepted because, even though one does not expect MAC_{NEW} to equal MAC_{CHECK}, one wants a value for MAC_{NEW} that only indicates R_{1A} has been changed to R_{1B} rather than that the change has occurred in blocks R₀, R₂, R₃, or R₄.

The processor is thus capable of performing two hashes in a parallel fashion. Alternatively, it is even possible that two processors could be used to operate on a single input. Alternatively, a chip could be fabricated using combinational logic and latches to implement the two bifurcated hashing paths rather than utilizing a processor.

According to yet another embodiment of the invention, a similar process can be implemented on a different storage technique. As taught by U.S. Pat. No. 5,754,659 entitled “Generation of Cryptographic Signatures Using Hash Keys,” which is incorporated herein by reference for all purposes, it is possible to store hashing keys for a significantly long data set. These hashing keys can be utilized in place of the original data to authenticate the data.

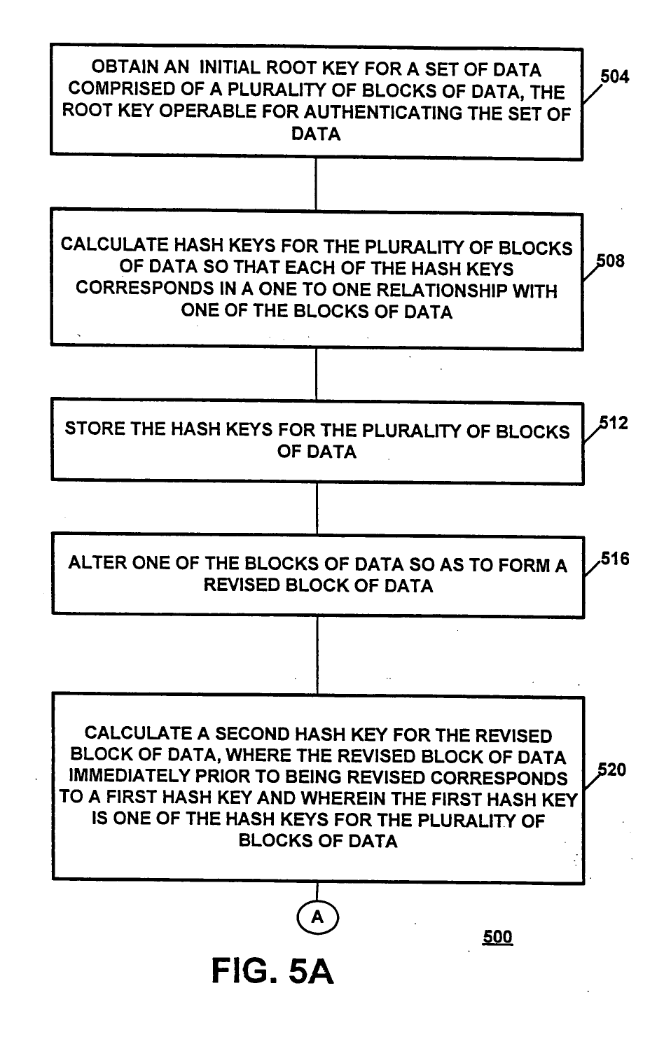

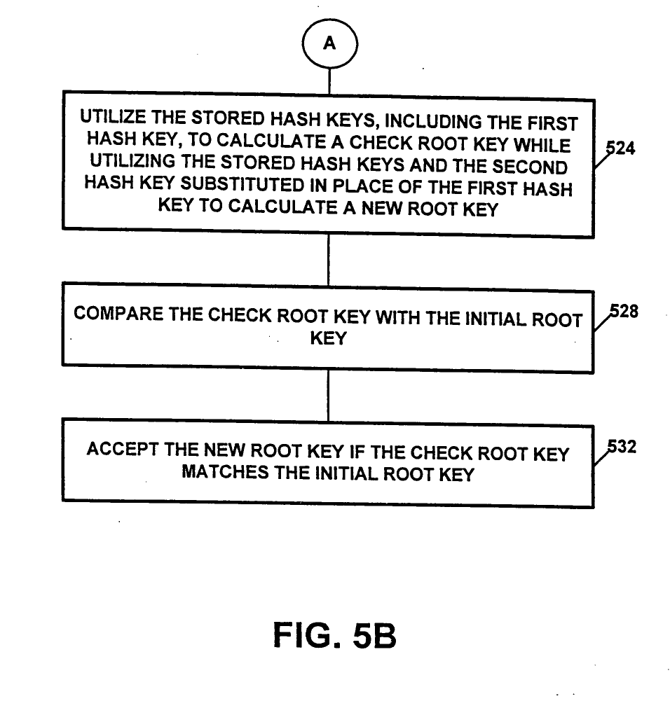

FIGS. 5A and 5B illustrate a flowchart 500 for implementing a method according to one embodiment of the invention. In block 504 an initial root key for a set of data comprised of a plurality of blocks of data is obtained. The root key is operable for authenticating the set of data. In block 508, hash keys are calculated for the plurality of blocks of data so that each of the hash keys corresponds in a one-to-one relationship with one of the blocks of data. In block 512, the hash keys for the plurality of blocks of data are stored.

One of the blocks of data can then be altered so as to form a revised block of data as shown in block 516. Furthermore, a second hash key can be calculated for the revised block of data, where the revised block of data immediately prior to being revised corresponds to a first hash key and wherein the first hash key is one of the hash keys for the original plurality of blocks of data, as shown in block 520. In block 524, one can utilize the stored hash keys, including the first hash key, to calculate a check root key while also utilizing the stored hash keys and a second hash key substituted in place of the first hash key to calculate a new root key. In block 528, the check root key is compared with the initial root key. If the check root key matches the initial root key, then the new root key is accepted, as shown in block 532.

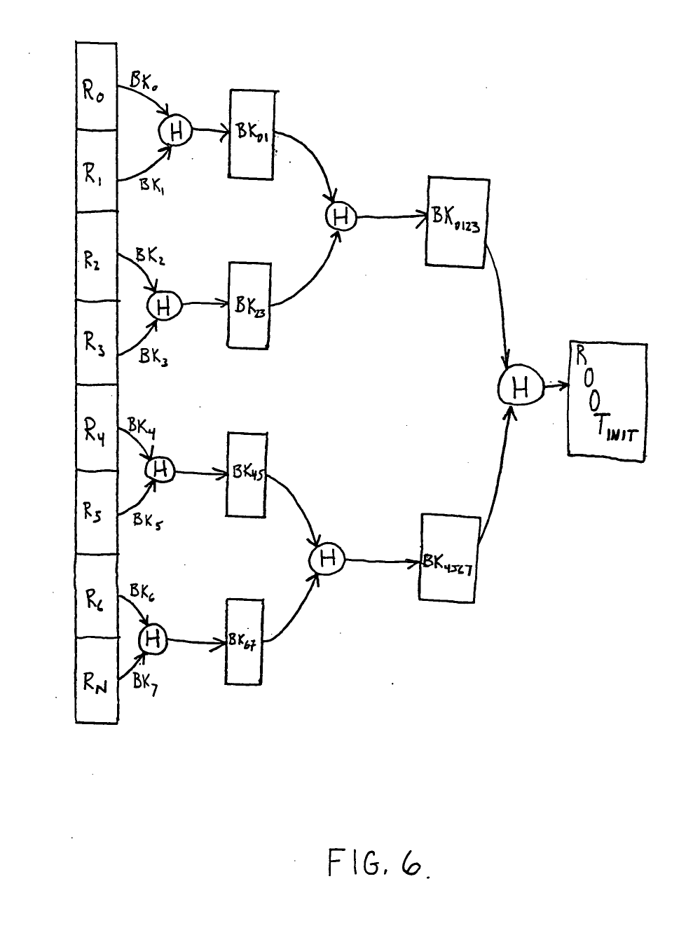

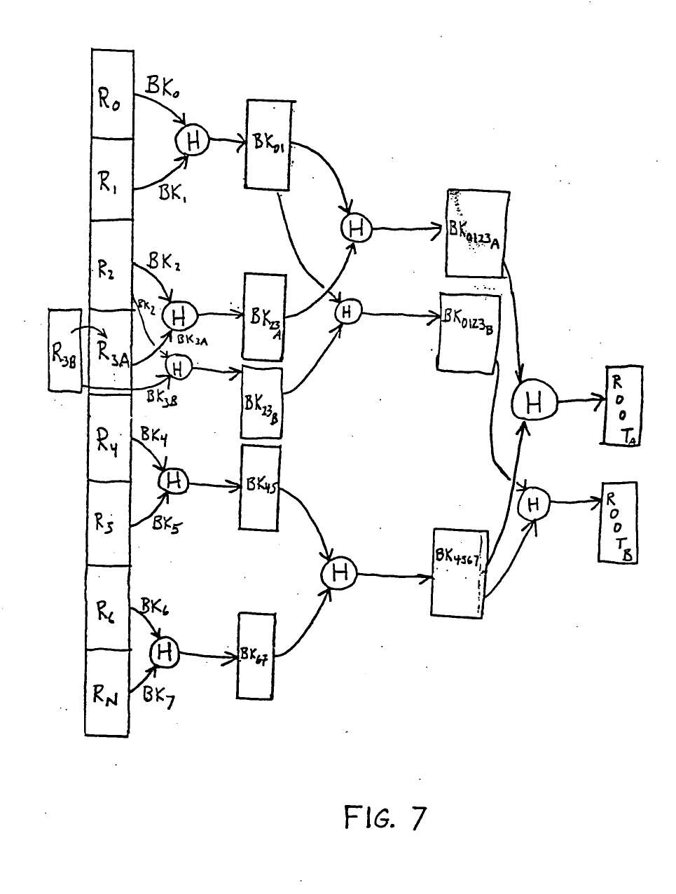

FIGS. 6 and 7 illustrate the embodiments discussed in FIGS. 5A and 5B by way of hashing diagrams. In FIG. 6, a string of data comprised of blocks R₀, R₁, R₂, R₃, R₄, R₅, R₆, and R_{N} are shown. Preferably, the number of blocks of data is an integral power of 2. FIG. 6 shows that block R₀ is hashed to form branch key BK₀. Block R₁ is hashed to form branch key BK₁, block R₂ is hashed to form branch key BK₂, block R₃ is hashed to form BK₃, block R₄ is hashed to form BK₄, block R₅ is hashed to form BK₅, block R₆ is hashed to form BK₆, and block R_{N} is hashed to form BK₇. Each hash key represents a hash result of the data that it corresponds to. The branch keys thus serve as a shorthand way of representing a much longer string of data. They can be encrypted and stored for authentication purposes. In FIG. 6, the branch keys are hashed further so as to obtain an initial root value for the entire string of data. Namely, BK₀ and BK₁ are hashed to form branch key BK₀, while BK₂ and BK₃ are hashed to form branch key BK₂₃. Furthermore, BK₄ and BK₅ are hashed to form branch key BK₄₅ while BK₆ and BK₇ are hashed to form branch key BK₆₇. The process is then repeated until ROOT_{INIT} is obtained. In FIG. 6, this is shown by calculation of BK₀₁₂₃ and BK₄₅₆₇ followed by calculation of ROOT_{INIT}. A branch key in this patent is utilized to refer to a result of a hash of data that is representative of the data for authentication purposes yet is not a root key for an entire set of data.

FIG. 7 illustrates the calculation of a check root and a putative new root. The same data string of R₀ through R_{N} is shown in FIG. 7. However, for block R_{3A}, the original value is shown as R_{3A} and a new value intended to replace R_{3A} is shown as block R_{3B}. The substitution of R_{3B} for R_{3A} is an intended substitution for an intended modification of the data string. It is not a revision due to an attack by an attacker.

For purposes of calculating a new root key and new branch keys for the string of data, the diagram in FIG. 7 illustrates the branch key hashing method.

For the string of data, a branch key BK₀ is calculated for block R₀ while a branch key BK₁ is calculated for block R₁. These branch keys are then hashed to form branch key BK₀₁. BK₀₁ should be the same for the revised string of data as it was for the original string of data, since neither BK₀ nor BK₁ changed. The block R₂ also was not changed and should yield branch key BK₂ when it is hashed. Block R_{3A} is the original value corresponding to block R₃ in FIG. 6. It is hashed to result in branch key BK_{3A}. The revised block of data R_{3B} is intended to replace block R_{3A}. It is hashed to compute branch key BK_{3B}. Upon detection of the revision to block R_{3A}, the corresponding pair to branch key BK_{3A}, namely BK₂, is read into the processor. BK₂ is hashed with BK_{3A} so as to produce BK_{23A}. The result, BK_{23A}, is stored in the processor, for example, while BK_{3B} is also hashed with BK₂. The result of hashing BK_{3B} with BK₂ produces BK_{23B}. Thus, this algorithm allows BK₂ to be hashed with both the branch key for original branch key BK_{3A} and new branch key BK_{3B}. The stored values are used again by reading in branch key BK₀₁ to the processor. BK₀₁ is then hashed with BK_{23A} so as to obtain branch key BK_{0123A}. This result is stored while the processor computes the hash of BK₀₁ and BK_{23B}. The result of this hash is branch key BK_{0123B}. Finally, branch key BK_{0123A} is hashed with branch key BK₄₅₆₇ to obtain ROOT_{A}. ROOT_{A} corresponds to a check root in view of the fact that it should be the same as the initial root computed in FIG. 6 since data R_{3A} is the original value R₃. ROOT_{A} is stored in the processor while branch keys BK₄₅₆₇ and BK_{0123B} are hashed to obtain ROOT_{B}. ROOT_{B} is the putative new root value. If ROOT_{A} matches ROOT_{INIT} from FIG. 6, then no changes have been made to the branch keys. Thus, it is proper to accept ROOT_{B} as the new root value for the data chain with data block R_{3B} substituted for block R_{3A}. This root is stored in the processor according to this example.

It is optional to what degree one computes the branch keys other than branch key BK_{3B}. Namely, one could recompute BK₄, BK₅, BK₆, BK₇, BK₀, and BK₁. However, branch keys are usually intended to reduce the processing of the original set of data and serve as a shorthand representation. Therefore, one might only choose to recompute the hashes affected by the changes from R_{3A} to R_{3B}. This would facilitate the quickest revision of the root key.

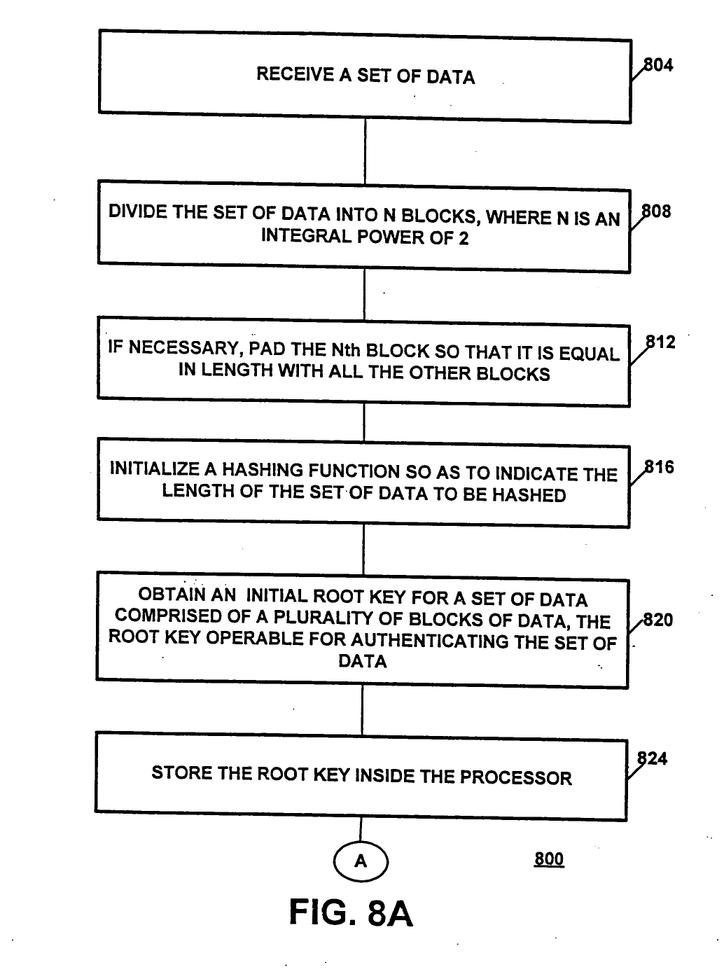

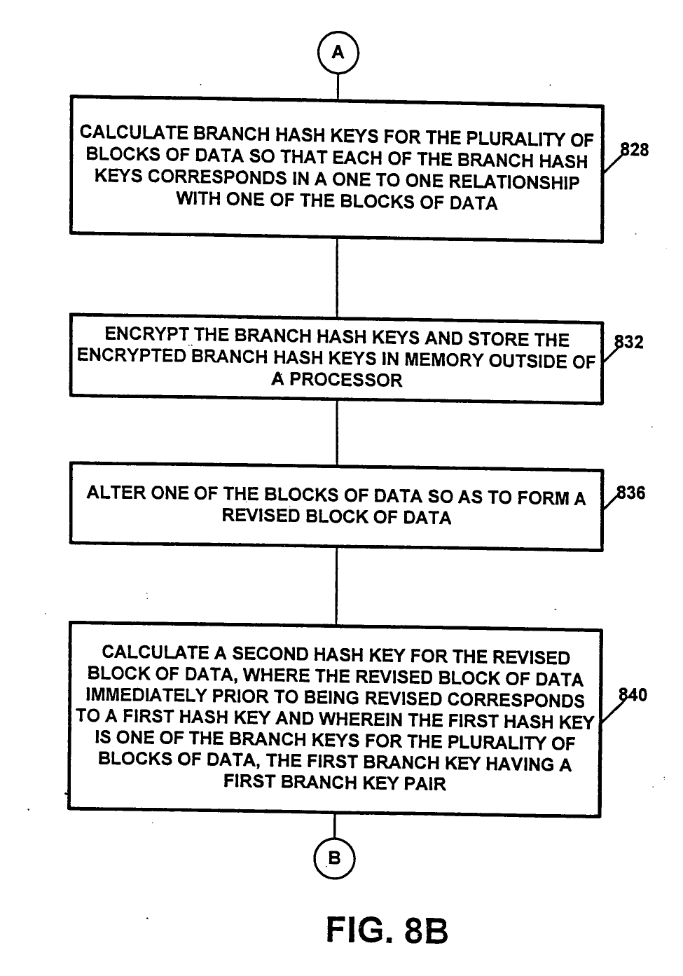

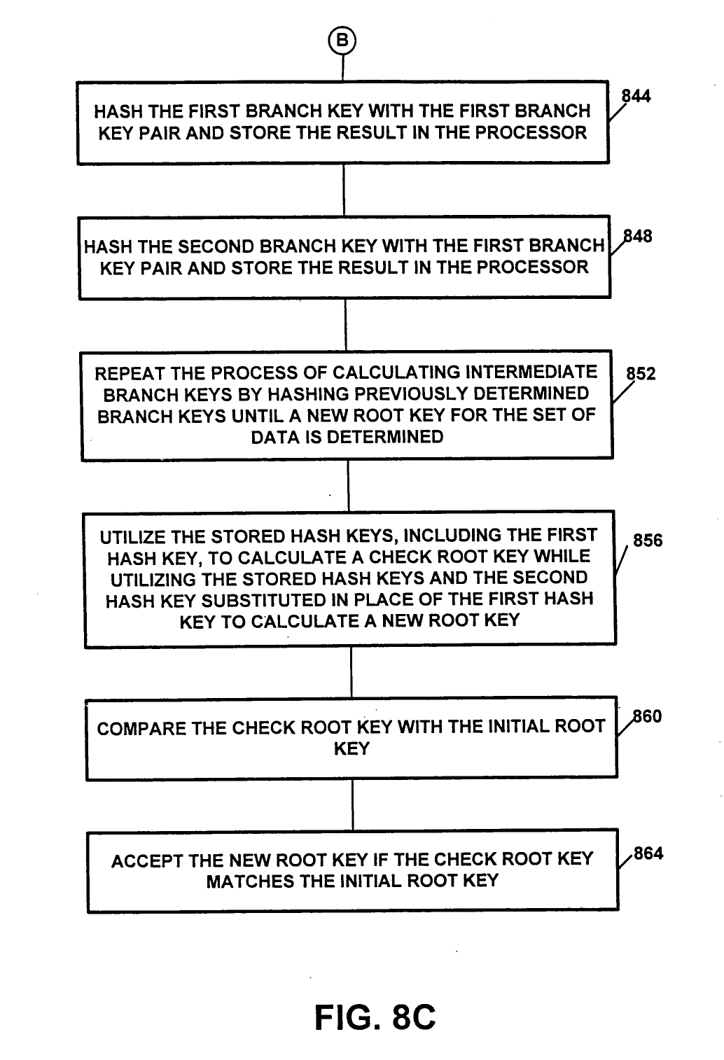

Referring now to FIGS. 8A, 8B, and 8C, a flowchart 800 for implementing one embodiment of the invention can be seen. In block 804 of flowchart 800, a set of data is received. The set of data is divided into N blocks where N is an integral power of 2, i.e., N=2^{Y} where Y is an integer, as shown in block 808. If necessary, the Nth block can be padded so that it is equal in length with all the other blocks as shown in block 812. Alternatively, one of the other blocks could also be padded. A hashing function is initialized so as to indicate the length of the set of data that is going to be hashed as shown in block 816. An initial root key is obtained for the set of data as shown in block 820 such that the root key is operable for authenticating the set of data. The root key can be computed in the manner shown in FIG. 6. The root key is stored inside the processor as illustrated by block 824. In block 828, branch hash keys are calculated for the plurality of blocks of data so that each of the branch hash keys corresponds in a one-to-one relationship with one of the blocks of data. The branch keys are encrypted and stored in memory such as memory outside a processor as shown in block 832. At this point, one of the blocks of data can be altered so as to form a revised block of data as illustrated by block 836. Upon altering one of the blocks of data, it will be time to calculate a new root key and branch keys affected by the data change. Thus, in block 840, a second hash key corresponding with the revised block of data is calculated where the revised block of data in its immediately prior form, i.e., prior to being revised, corresponds with a first hash key. The first hash key is one of the original branch keys for the plurality of blocks of data. Furthermore, the first branch key has a key pair with which it is hashed to obtain a subsequent branch key. Thus, BK₁ in FIG. 7 is a branch key pair of BK₀. In block 844, the first branch key is hashed with the first branch key pair and the result is stored in the processor. Furthermore, in block 848, the second branch key is hashed with the first branch key pair and the result is stored in the processor. In block 852, the process is repeated of calculating intermediate branch keys by hashing previously determined branch keys until a new root key for the set of data is determined. This can be seen in FIG. 7 where new branch keys that were affected by the data change are calculated. In block 856, the stored hash keys, including the first hash key, are utilized to calculate a check root key while concurrently utilizing the stored hash keys and the second hash key substituted in place of the first hash key to calculate a new root key. The check root key is compared with the initial root key in block 860 and if the check root key matches the initial root key, the new root key is accepted as shown by block 864.

While various embodiments of the invention have been described as methods or apparatuses for implementing the invention, it should be understood that the invention can be implemented through code coupled to a computer, e.g., code resident on a computer or accessible by the computer. For example, software could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents, including the matter incorporated by reference.

While the above is a complete description of specific embodiments of the invention, the above description should not be taken as limiting the scope of the invention as defined by the claims.

1. A method of authenticating a set of N information blocks, said method comprising:
obtaining an initial hash value for a set of N information blocks, wherein N is an integer;
altering one of said N information blocks from said set of N information blocks so as to form a revised set of N information blocks;
calculating a revised hash value for said revised set of N information blocks; while
calculating a check hash value for said N information blocks; then
comparing said check hash value with said initial hash value;
accepting said revised hash value for said revised set of N information blocks if said check hash value matches said initial hash value.

2. The method as described in claim 1 wherein said calculating said revised hash value while calculating said check hash value comprises:
calculating said revised hash value in parallel with said check hash value.

3. The method as described in claim 1 wherein said calculating said revised hash value while calculating said check hash value comprises:
hashing said altered block of data so as to obtain a first hashing result;
storing said first hashing result in a processor; and then
hashing the corresponding unaltered block of data so as to obtain a second hashing result.

4. The method as described in claim 1 wherein said calculating said revised hash value while calculating said check hash value comprises:
concurrently hashing said altered block of data so as to obtain a first hashing result and hashing the corresponding unaltered block of data so as to obtain a second hashing result.

5. The method as described in claim 1 wherein said calculating said revised hash value while calculating said check hash value comprises:
utilizing a single processor to calculate said revised hash value and to calculate said check hash value.

6. The method as described in claim 1 and further comprising:
performing a linear hash of said set of data by hashing said N blocks of data in sequential order from block 1 to block N.

7. The method as described in claim 1 wherein said obtaining said initial hash value for said set of N information blocks comprises:
hashing each of said N information blocks in said set of N information blocks.

8. The method as described in claim 1 and further comprising:
storing said initial hash value in a processor.

9. The method as described in claim 1 wherein said altering one of said N information blocks comprises:
storing a new value for at least part of one of said N information groups.

10. The method as described in claim 1 wherein said comparing said check hash value with said initial hash value comprises:
determining whether said check hash value and said initial hash value are exactly the same.

11. The method as described in claim 1 wherein said accepting said revised hash value comprises:
replacing said initial hash value with said revised hash value.

12. The method as described in claim 1 and further comprising:
storing the new revised hash value in the memory area previously occupied by the initial hash value.

13. The method as described in claim 1 and further comprising:
not accepting said revised hash value as a replacement for said initial hash value if said check hash value does not match said initial hash value.

14. The method as described in claim 13 and further comprising:
indicating a failure to authenticate.

15. The method as described in claim 1 and further comprising:
utilizing said set of data for digital rights management.

16. The method as described in claim 1 and further comprising:
replacing said initial hash value with said revised hash value.

17. The method as described in claim 1 and further comprising:
receiving as part of an initialization routine a length of a data set to be hashed, wherein said data set is comprised of said N information groups.

18. The method as described in claim 17 and further comprising:
padding at least one of said N information groups so that each of said N information groups is of equal length.

19. The method as described in claim 1 and further comprising:
initializing a processor so as to perform a hashing routine.

20. The method as described in claim 1 and further comprising:
initializing a hashing routine by entering the length of said set of data.

21. The method as described in claim 1 and further comprising:
dividing the set of data into a plurality of blocks.

22. The method as described in claim 1 and further comprising:
dividing the set of data into a plurality of blocks of data;
padding the last block of data so that each of said blocks of data is of equal length.

23. A method of authenticating a set of N information blocks, said method comprising:
obtaining an initial root key for a set of data comprised of a plurality of blocks of data, said root key operable for authenticating said set of data;
calculating hash keys for said plurality of blocks of data so that each of said hash keys corresponds to only one of said blocks of data and so that each of said blocks of data corresponds to only one of said hash keys;
storing said hash keys for said plurality of blocks of data;
altering one of said blocks of data so as to form a revised block of data;
calculating a second hash key for said revised block of data, wherein said revised block of data immediately prior to being revised corresponds to a first hash key and wherein said first hash key is one of said hash keys for said plurality of blocks of data;
utilizing said stored hash keys, including said first hash key, to calculate a check root key while utilizing said stored hash keys and said second hash key substituted in place of said first hash key to calculate a new root key;
comparing said check root key with said initial root key;
accepting said new root key if said check root key matches said initial root key.

24. The method as described in claim 23 wherein said utilizing said stored hash keys, including said first hash key, to calculate said check root key is done in parallel with said utilizing said stored hash keys and said second hash key substituted in place of said first hash key to calculate said new root key.

25. The method as described in claim 24 and further comprising:
computing a branch key;
hashing said branch key and said first hash key; and
hashing said branch key and said second hash key.

26. The method as described in claim 24 and further comprising:
computing a branch key;
hashing said branch key and said first hash key; while
hashing said branch key and said second hash key.

27. The method as described in claim 24 and further comprising:
computing a branch key; and concurrently
computing a result from said branch key and said first hash key; while
computing a result from said branch key and said second hash key.

28. The method as described in claim 24 and further comprising:
utilizing a single processor to calculate said check root key and said new root key.

29. The method as described in claim 23 and further comprising:
dividing an initial set of data into X blocks, where X is equal to 2 raised to the Y power and where Y is an integer.

30. The method as described in claim 23 and further comprising:
calculating intermediate branch keys by hashing previously determined branch keys; and then
utilizing said intermediate branch keys to calculate said new root key.

31. The method as described in claim 23 and further comprising:
encrypting said hash keys for said plurality of blocks; and
storing said encrypted hash keys in memory outside of a processor.

32. The method as described in claim 23 and further comprising:
storing said hash keys for said plurality of blocks in a processor.

33. The method as described in claim 23 and further comprising:
storing said root key inside a processor.

34. The method as described in claim 23 wherein said altering one of said blocks of data comprises:
storing a new value for at least part of one of said information groups

35. The method as described in claim 23 wherein said comparing said check root key with said initial root key comprises:
determining whether said check root key and said initial root key are exactly the same.

36. The method as described in claim 23 wherein said accepting said new root key comprises replacing said initial root key with said new root key.

37. The method as described in claim 36 and further comprising:
storing said new root key in a processor in a memory area previously occupied by said initial root key.

38. The method as described in claim 23 wherein said set of N information blocks is at least partially utilized for managing digital rights.

39. The method as described in claim 23 wherein said set of N information blocks is at least partially utilized as an entitlement control message for receiving a program.

40. The method as described in claim 23 and further comprising:
initializing a hashing function by receiving the length of said N information blocks.

41. The method as described in claim 40 and further comprising:
padding the final block of the N information blocks prior to hashing the Nth block.

42. The method as described in claim 23 and further comprising:
initializing a hashing function.

43. The method as described in claim 23 and further comprising:
obtaining a set of data; and
dividing said set of data into a plurality of blocks.
